(19) United States
(12) Patent Application Publication
(10) Pub. No.: US 2024/0211311 A1
(43) Pub. Date: Jun. 27, 2024

(54) SYSTEM AND METHOD FOR A DECENTRALIZED FINANCIAL SIMULATION AND DECISION PLATFORM

(71) Applicant: QOMPLX LLC, Reston, VA (US)

(72) Inventors: Jason Crabtree, Vienna, VA (US); Andrew Sellers, Monument, CO (US)

(21) Appl. No.: 18/596,582

(22) Filed: Mar. 5, 2024

Related U.S. Application Data
(63) Continuation of application No. 17/088,387, filed on Nov. 3, 2020.
Application No. 17/088,387 is a continuation-in-part of application No. 16/945,698, filed on Jul. 31, 2020, now abandoned.
Application No. 16/945,698 is a continuation-in-part of application No. 16/864,133, filed on Apr. 30, 2020, now Pat. No. 11,494,665.
Application No. 16/864,133 is a continuation-in-part of application No. 15/847,443, filed on Dec. 19, 2017, now abandoned.
Application No. 15/847,443 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017, now abandoned.
Application No. 15/616,427 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
Application No. 17/088,387 is a continuation-in-part of application No. 16/945,698, filed on Jul. 31, 2020, now abandoned.
Application No. 16/945,698 is a continuation-in-part of application No. 16/864,133, filed on Apr. 30, 2020, now Pat. No. 11,494,665.
Application No. 16/864,133 is a continuation-in-part of application No. 15/847,443, filed on Dec. 19, 2017, now abandoned.
Application No. 15/847,443 is a continuation-in-part of application No. 15/616,427, filed on Jun. 7, 2017, now abandoned.
Application No. 15/616,427 is a continuation-in-part of application No. 14/925,974, filed on Oct. 28, 2015, now abandoned.
Application No. 17/088,387 is a continuation-in-part of application No. 16/945,698, filed on Jul. 31, 2020, now abandoned.
Application No. 16/945,698 is a continuation-in-part of application No. 16/864,133, filed on Apr. 30, 2020, now Pat. No. 11,494,665.
Application No. 16/864,133 is a continuation-in-part of application No. 15/847,443, filed on Dec. 19, 2017, now abandoned.
Application No. 15/847,443 is a continuation-in-part of application No. 15/489,716, filed on Apr. 17, 2017, now abandoned.
Application No. 15/489,716 is a continuation-in-part of application No. 15/409,510, filed on Jan. 18, 2017, now abandoned.
Application No. 15/409,510 is a continuation-in-part of application No. 15/379,899, filed on Dec. 15, 2016, now abandoned.
Application No. 15/379,899 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016, now abandoned.
Application No. 15/206,195 is a continuation-in-part of application No. 15/186,453, filed on Jun. 18, 2016, now abandoned.
Application No. 15/186,453 is a continuation-in-part of application No. 15/166,158, filed on May 26, 2016, now abandoned.
Application No. 15/166,158 is a continuation-in-part of application No. 15/141,752, filed on Apr. 28, 2016, now Pat. No. 10,860,962.
Application No. 17/088,387 is a continuation-in-part of application No. 16/945,698, filed on Jul. 31, 2020, now abandoned.
Application No. 16/945,698 is a continuation-in-part of application No. 16/915,176, filed on Jun. 29, 2020, now abandoned.
Application No. 16/915,176 is a continuation-in-part of application No. 15/847,443, filed on Dec. 19, 2017, now abandoned.
Application No. 15/847,443 is a continuation-in-part of application No. 15/891,329, filed on Feb. 7, 2018, now abandoned.
Application No. 15/891,329 is a continuation-in-part of application No. 15/860,980, filed on Jan. 3, 2018, now abandoned.
Application No. 15/860,980 is a continuation-in-part of application No. 15/850,037, filed on Dec. 21, 2017, now abandoned.
Application No. 15/850,037 is a continuation-in-part of application No. 15/489,716, filed on Apr. 17, 2017, now abandoned.
Application No. 15/489,716 is a continuation-in-part of application No. 15/673,368, filed on Aug. 9, 2017, now abandoned.
Application No. 15/673,368 is a continuation-in-part of application No. 15/376,657, filed on Dec. 13, 2016, now Pat. No. 10,402,906.
Application No. 17/088,387 is a continuation-in-part of application No. 16/945,698, filed on Jul. 31, 2020, now abandoned.
Application No. 16/945,698 is a continuation-in-part of application No. 16/915,176, filed on Jun. 29, 2020, now abandoned.
Application No. 16/915,176 is a continuation-in-part of application No. 15/891,329, filed on Feb. 7, 2018, now abandoned.
Application No. 15/891,329 is a continuation-in-part of application No. 15/860,980, filed on Jan. 3, 2018, now abandoned.
Application No. 15/860,980 is a continuation-in-part of application No. 15/788,002, filed on Oct. 19, 2017, now abandoned.
Application No. 15/788,002 is a continuation-in-part of application No. 15/787,601, filed on Oct. 18, 2017, now Pat. No. 10,860,660.
Application No. 15/787,601 is a continuation-in-part of application No. 15/616,427, filed on Jun. 7, 2017, now abandoned.
Application No. 17/088,387 is a continuation-in-part of application No. 16/945,698, filed on Jul. 31, 2020, now abandoned.
Application No. 16/945,698 is a continuation-in-part of application No. 16/915,176, filed on Jun. 29, 2020, now abandoned.
Application No. 16/915,176 is a continuation-in-part of application No. 15/905,041, filed on Feb. 26, 2018, now Pat. No. 10,706,063.
Application No. 15/905,041 is a continuation-in-part of application No. 15/237,625, filed on Aug. 15, 2016, now Pat. No. 10,248,910.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/777,270, filed on Jan. 30, 2020, now Pat. No. 11,025,674.
Application No. 16/777,270 is a continuation-in-part of application No. 16/720,383, filed on Dec. 19, 2019, now Pat. No. 10,944,795.
Application No. 16/720,383 is a continuation-in-part of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017, now abandoned.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 15/683,765, filed on Aug. 22, 2017, now abandoned.
Application No. 15/683,765 is a continuation-in-part of application No. 15/409,510, filed on Jan. 18, 2017, now abandoned.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/718,906, filed on Dec. 18, 2019, now Pat. No. 11,055,140.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017, now abandoned.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 15/905,041, filed on Feb. 26, 2018, now Pat. No. 10,706,063.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/191,054, filed on Nov. 14, 2018, now Pat. No. 10,681,074.
Application No. 16/191,054 is a continuation-in-part of application No. 15/655,113, filed on Jul. 20, 2017, now Pat. No. 10,735,456.
Application No. 15/655,113 is a continuation-in-part of application No. 15/237,625, filed on Aug. 15, 2016, now Pat. No. 10,248,910.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/654,309, filed on Oct. 16, 2019, now abandoned.
Application No. 16/654,309 is a continuation-in-part of application No. 15/847,443, filed on Dec. 19, 2017, now abandoned.
Application No. 17/088,387 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/660,727, filed on Oct. 22, 2019, now Pat. No. 10,938,683.
Application No. 16/660,727 is a continuation of application No. 15/229,476, filed on Aug. 5, 2016, now Pat. No. 10,454,791.
Application No. 15/229,476 is a continuation-in-part of application No. 15/206,195, filed on Jul. 8, 2016, now abandoned.
(60) Provisional application No. 62/568,298, filed on Oct. 4, 2017.
(60) Provisional application No. 62/568,291, filed on Oct. 4, 2017.
(60) Provisional application No. 62/568,305, filed on Oct. 4, 2017.
(60) Provisional application No. 62/568,312, filed on Oct. 4, 2017.

(51) Int. Cl. G06F 9/50; G06N 5/025; G06Q 10/067; G06Q 30/0201; G06Q 30/0204; G06Q 40/04

(52) U.S. Cl. CPC G06F 9/5011; G06N 5/025; G06Q 10/067; G06Q 30/0201; G06Q 30/0205; G06Q 40/04

(57) ABSTRACT

A system and method for a decentralized financial simulation and decision platform has a model definition language service configured to create a first dataset comprising at least a user-defined set of computing instructions comprising at least instructions regarding data flow locality, a parametric evaluator configured to retrieve the first dataset, and process the first dataset by performing at least a plurality of transformations and predictive analysis on the first dataset and specifying at least an intended focus on financial trading, and an optimizer configured to retrieve the processed first dataset from the parametric evaluator and determine an optimal locality for executing a trade.

### CROSS-REFERENCE TO RELATED APPLICATIONS

Priority is claimed in the application data sheet to the following patents or patent applications, each of which is expressly incorporated herein by reference in its entirety:
Ser. No. 17/088,387
Ser. No. 16/945,698
Ser. No. 16/864,133
Ser. No. 15/847,443
Ser. No. 15/790,457
62/568,298
Ser. No. 15/790,327
62/568,291
Ser. No. 15/616,427
Ser. No. 15/141,752
Ser. No. 15/091,563
Ser. No. 14/986,536
Ser. No. 14/925,974
Ser. No. 15/489,716
Ser. No. 15/409,510
Ser. No. 15/379,899
Ser. No. 15/376,657
Ser. No. 15/237,625
Ser. No. 15/206,195
Ser. No. 15/186,453
Ser. No. 15/166,158
Ser. No. 16/915,176
Ser. No. 15/891,329
Ser. No. 15/860,980
Ser. No. 15/850,037
Ser. No. 15/673,368
Ser. No. 15/788,002
62/568,305
Ser. No. 15/787,601
62/568,312
Ser. No. 15/905,041
Ser. No. 15/931,534
Ser. No. 16/777,270
Ser. No. 16/720,383
Ser. No. 15/823,363
Ser. No. 15/725,274
Ser. No. 15/655,113
Ser. No. 15/683,765
Ser. No. 16/718,906
Ser. No. 15/879,182
Ser. No. 16/191,054
Ser. No. 16/654,309
Ser. No. 16/660,727
Ser. No. 15/229,476

### BACKGROUND OF THE INVENTION

### Field of the Invention

The disclosure relates to the field of use of computer systems in business information management, operations, and predictive planning; particularly to a geographically distributed computer system.

### Discussion of the State of the Art

One method of trading that exists in financial trading is what is referred to as high-frequency trading (HFT), in which large positions in stocks and other financial assets may last for fractions of a second, and profits per unit of asset may be as low fractions of a cent. HFT is commonly conducted with the use of computer algorithms, and it is estimated that the majority of executed trades are of the HFT type. Due to the rapid and high-speed nature, the connections in which the computer systems conducting the trades may be crucial to maximizing profits. While generally not a problem when a trade is executed close to a market center, for example a trader executing a trade in New York to the NEW YORK STOCK EXCHANGE, the problem may become readily apparent when conducting trades on a global scale, wherein the added latency of executing trades across continents may cause missing of a price target. While some advances have been made by implementing intermediate points in which a trade may be executed, the solution may not be sufficient. For instance, even when latency is accounted for, connection conditions may be affected by external factors, such as a power outage, traffic loads, routing problems, and the like.

What is a needed is a linked distributed system operating that conducts trades to not only reduce latency, but to also take into account exogeneous factors that may affect connections. Such a system should be able to reroute an order, if required, and intelligently choose localities for computing to reduce trade latency.

### SUMMARY OF THE INVENTION

Accordingly, the inventor has conceived, and reduced to practice, a system and method for a decentralized financial simulation and decision platform.

In typical embodiment, a system is provided that, in addition to forecasting changes and fluctuations of a financial market with the use of specialized models, may be configured to operate in a decentralized manner. Through the use of services and models, the system may evaluate connections, data localities, processing localities, and the like to determine a best course of action in executing a financial trade with regards to factors such as reduced connect latency, and profitability stemming from global arbitrage transactions.

In one embodiment of the invention, a system for a decentralized financial simulation and decision platform is provided comprising: at least one computing device, comprising a first memory and a first processor; a decentralized trading platform, comprising a first plurality of programming instructions stored in the memory of and operable on the processor of the computing device, wherein the first plurality of programming instructions, when operating on the processor, cause the decentralized trading platform to: define a domain specific language for a trading performance model, the trading performance model comprising a computing environment, a trading performance parameter, and a set of rules, the computing environment further comprising: a plurality of trading computers, located proximally to at least one trading exchange, and the location, trading configuration, and trading data of the plurality of trading computers; a trading system control point server, and the location, trading configuration, and trading data of the trading system control point server; an end-user computer, and the location, trading configuration, and trading data of the end-user computer; send the domain specific language and trading performance model to the plurality of trading computers for evaluation; receive the test results from the plurality of trading computers; an optimizer comprising a second plurality of programming instructions stored in the first memory and operable on the first processor, wherein the second plurality of programming instructions, when operating on the first processor, cause the computing device to: receive the test results from the plurality of trading computers; determine an optimal configuration for trading based on the test results, the optimal configuration comprising a determination of what types of trades and what volumes of trades should be executed at which exchanges to reduce execution latency; and implement the optimal configuration by distributing orders for trades among the plurality of trading computers; the plurality of trading computers, each comprising a second memory and a second processor, each trading computer being located proximally to a different trading exchange from each of the other trading computers, wherein each of the plurality of trading computers is configured to: receive the domain specific language and trading performance model from the decentralized trading platform; a rules engine, comprising a third plurality of programming instructions stored in the memory of and operable on the second processor of each trading computer, wherein the third plurality of programming instructions, when operating on the second processor, cause the rules engine to: analyze the trading performance model according to a set of rules contained within the domain specific language; conduct one or more tests of the trading performance model at the location of the trading computer using the set of rules contained in the domain specific language to obtain a test result, the test result comprising a type of trade or a volume of trades that would be optimally placed at the location of the trading computer; wherein the domain specific language is deployed at each of the plurality of trading computers, and computed separately using each trading computer's own location, real or simulated latency to a trading exchange, and hardware specifications, for evaluation of heterogeneous trading computers and trading exchanges for a given trade, simulated trade, or trading model; and send the test result to the computing device.

According to another embodiment of the invention, a method for using a decentralized financial simulation and decision platform is provided, comprising the steps of: defining a domain specific language for a trading performance model, the trading performance model comprising a computing environment, a trading performance parameter, and a set of rules, using a decentralized trading platform, the computing environment comprising: a plurality of trading computers, located proximally to at least one trading exchange, and the location, trading configuration, and trading data of the plurality of trading computers; a trading system control point server, and the location, trading configuration, and trading data of the trading system control point server; an end-user computer, and the location, trading configuration, and trading data of the end-user computer; sending the domain specific language and trading performance model to the plurality of trading computers for evaluation, using a decentralized trading platform; receiving the test results from the plurality of trading computers, using a decentralized trading platform; receiving the test results from the plurality of trading computers, using an optimizer; determining an optimal configuration for trading based on the test results, the optimal configuration comprising a determination of what types of trades and what volumes of trades should be executed at which exchanges to reduce execution latency, using an optimizer; implementing the optimal configuration by distributing orders for trades among the plurality of trading computers, using an optimizer; receiving the domain specific language and trading performance model from the decentralized trading platform, using a plurality of trading computers; analyzing the trading performance model according to a set of rules contained within the domain specific language, using a rules engine; conducting one or more tests of the trading performance model at the location of the trading computer using the set of rules contained in the domain specific language to obtain a test result, the test result comprising a type of trade or a volume of trades that would be optimally placed at the location of the trading computer, using a rules engine; wherein the domain specific language is deployed at each of the plurality of trading computers, and computed separately using each trading computer's own location, real or simulated latency to a trading exchange, and hardware specifications, for evaluation of heterogeneous trading computers and trading exchanges for a given trade, simulated trade, or trading model, using a rules engine; and sending the test result to the computing device, using a rules engine.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary architecture of a business operating system according to an embodiment of the invention.

FIG. 2A is a diagram of modules of the business operating system configured specifically for use in investment vehicle management according to an embodiment of the invention.

FIG. 2B is an extension of the system shown in FIG. 2A showing directed computational graph module further configured to perform financial data analysis using its associated transformer service module according to various embodiments of the invention.

FIG. 2C is an extended connector module as illustrated in FIG. 2A.

FIG. 3 is a flow diagram of an exemplary function of the business operating system in the calculation of future investment performance.

FIG. 4 is a diagram of an indexed global tile module 400 as per one embodiment of the invention.

FIG. 5 is a diagram of an exemplary architecture of a regulatory label aware message routing system per an embodiment.

FIG. 6 is a flow diagram of an exemplary function of a regulatory message label aware message routing system in routing sensitive electronic messages per an embodiment.

FIG. 7 is a diagram illustrating the use of routing regulatory labels to create availability zones.

FIG. 8 is a block diagram of an exemplary system architecture for a system for decentralized trading according to various embodiments of the invention.

FIG. 9 is an illustration of an exemplary topography of a system employing a plurality of decentralized trading systems according to various embodiments of the invention.

FIG. 10 is a flow diagram for an exemplary method for model evaluation using a parametric evaluator according to various embodiments of the invention.

FIG. 11 is a flow diagram for an exemplary method for optimizing a request according to various embodiments of the invention.

FIG. 12 is a block diagram illustrating an exemplary hardware architecture of a computing device used in various embodiments of the invention.

FIG. 13 is a block diagram illustrating an exemplary logical architecture for a client device, according to various embodiments of the invention.

FIG. 14 is a block diagram illustrating an exemplary architectural arrangement of clients, servers, and external services, according to various embodiments of the invention.

FIG. 15 is another block diagram illustrating an exemplary hardware architecture of a computing device used in various embodiments of the invention.

### DETAILED DESCRIPTION OF THE INVENTION

Accordingly, the inventor has conceived, and reduced to practice, a system and method for a decentralized financial simulation and decision platform.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, a “vector” may be defined as a container for compute instructions, and may comprise instructions and descriptions for data locality, process locality, priority, type, search, approach, and the like. Vectors may also be used in a search process, and for declaration of constraints regarding the conditions under which specific actions may be taken, limitations on inputs, limitations on outputs, limitations on downstream uses to be attached to outputs, and the like.

As used herein, a “run” may be a vector which has been evaluated and processed by a parameterized model execution engine according to various factors contributing to overall utility and objective function optimization.

### Conceptual Architecture

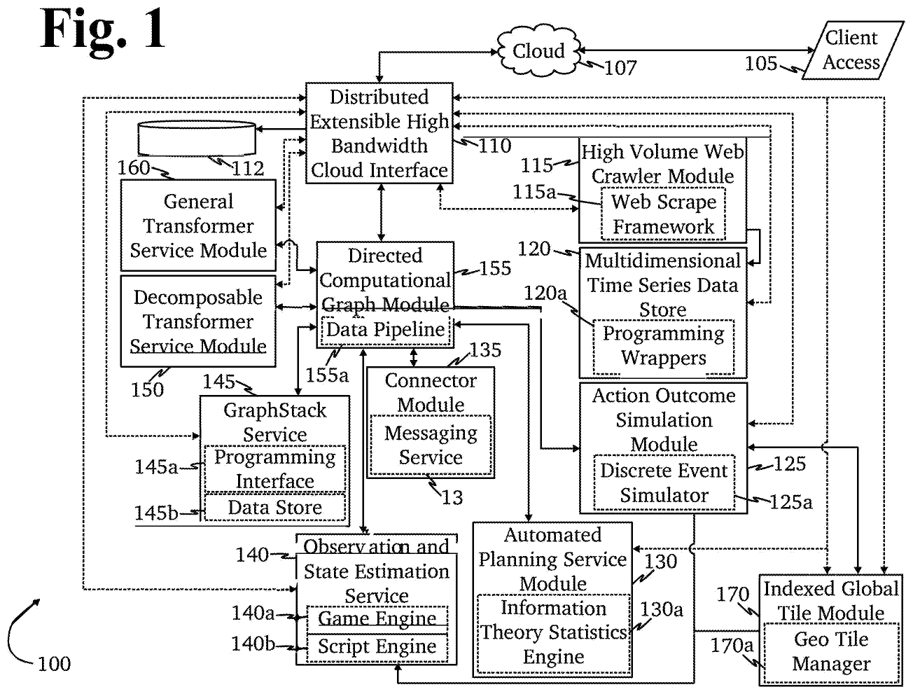

FIG. 1 is a diagram of an exemplary architecture of an advanced decentralized financial decision platform 100 according to an embodiment of the invention. Client access 105 to system or platform 100 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information and a data store 112 such as, but not limited to MONGODB™, COUCHDB™, CASSANDRA™ or REDIS™ depending on the embodiment. Much of the business data analyzed by the system both from sources within the confines of the client business, and from cloud based sources 107, public or proprietary such as, but not limited to: subscribed business field specific data services, external remote sensors, subscribed satellite image and data feeds and web sites of interest to business operations both general and field specific, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database 120 and a graph stack service 145. Directed computational graph module 155 retrieves one or more streams of data from a plurality of sources, which includes, but is not limited to, a plurality of physical sensors, network service providers, web-based questionnaires and surveys, monitoring of electronic infrastructure, crowd sourcing campaigns, and human input device information. Within directed computational graph module 155, data may be split into two identical streams in a specialized pre-programmed data pipeline 155a, wherein one sub-stream may be sent for batch processing and storage while the other sub-stream may be reformatted for transformation pipeline analysis. The data may be then transferred to a general transformer service module 160 for linear data transformation as part of analysis or the decomposable transformer service module 150 for branching or iterative transformations that are part of analysis. Directed computational graph module 155 represents all data as directed graphs where the transformations are nodes and the result messages between transformations edges of the graph. High-volume web crawling module 115 may use multiple server hosted preprogrammed web spiders which, while autonomously configured, may be deployed within a web scraping framework 115a of which SCRAPY™ is an example, to identify and retrieve data of interest from web based sources that are not well tagged by conventional web crawling technology. Multiple dimension time series data store module 120 may receive streaming data from a large plurality of sensors that may be of several different types. Multiple dimension time series data store module 120 may also store any time series data encountered by system 100 such as, but not limited to, environmental factors at insured client infrastructure sites, component sensor readings and system logs of some or all insured client equipment, weather and catastrophic event reports for regions an insured client occupies, political communiques and/or news from regions hosting insured client infrastructure and network service information captures (such as, but not limited to, news, capital funding opportunities and financial feeds, and sales, market condition), and service related customer data. Multiple dimension time series data store module 120 may accommodate irregular and high-volume surges by dynamically allotting network bandwidth and server processing channels to process the incoming data. Inclusion of programming wrappers 120a for languages—examples of which may include, but are not limited to, C++, PERL, PYTHON, and ERLANG™—allows sophisticated programming logic to be added to default functions of multidimensional time series database 120 without intimate knowledge of the core programming, greatly extending breadth of function. Data retrieved by multidimensional time series database 120 and high-volume web crawling module 115 may be further analyzed and transformed into task-optimized results by directed computational graph 155 and associated general transformer service 160 and decomposable transformer service 150 modules. Alternately, data from the multidimensional time series database and high-volume web crawling modules may be sent, often with scripted cuing information determining important vertices 145a, to graph stack service module 145 which, employing standardized protocols for converting streams of information into graph representations of that data, for example open graph internet technology (although the invention is not reliant on any one standard). Through the steps, graph stack service module 145 represents data in graphical form influenced by any pre-determined scripted modifications 145a and stores it in a graph-based data store 145b such as GIRAPH™ or a key-value pair type data store REDIS™, or RIAK™, among others, any of which are suitable for storing graph-based information.

Results of the transformative analysis process may then be combined with further client directives, additional business rules and practices relevant to the analysis and situational information external to the data already available in automated planning service module 130, which also runs powerful information theory-based predictive statistics functions and machine learning algorithms 130a to allow future trends and outcomes to be rapidly forecast based upon the current system derived results and choosing each a plurality of possible business decisions. Then, using all or most available data, automated planning service module 130 may propose business decisions most likely to result in favorable business outcomes with a usably high level of certainty. Closely related to the automated planning service module 130 in the use of system-derived results in conjunction with possible externally supplied additional information in the assistance of end user business decision making, action outcome simulation module 125 with a discrete event simulator programming module 125a coupled with an end user-facing observation and state estimation service 140, which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

A significant proportion of the data that is retrieved and transformed by the business operating system, both in real world analyses and as predictive simulations that build upon intelligent extrapolations of real world data, may include a geospatial component. The indexed global tile module 170 and its associated geo tile manager 170a may manage externally available, standardized geospatial tiles and may enable other components of the business operating system, through programming methods, to access and manipulate meta-information associated with geospatial tiles and stored by the system. The business operating system may manipulate this component over the time frame of an analysis and potentially beyond such that, in addition to other discriminators, the data is also tagged, or indexed, with their coordinates of origin on the globe. This may allow the system to better integrate and store analysis specific information with all available information within the same geographical region. Such ability makes possible not only another layer of transformative capability, but may greatly augment presentation of data by anchoring to geographic images including satellite imagery and superimposed maps both during presentation of real-world data and simulation runs.

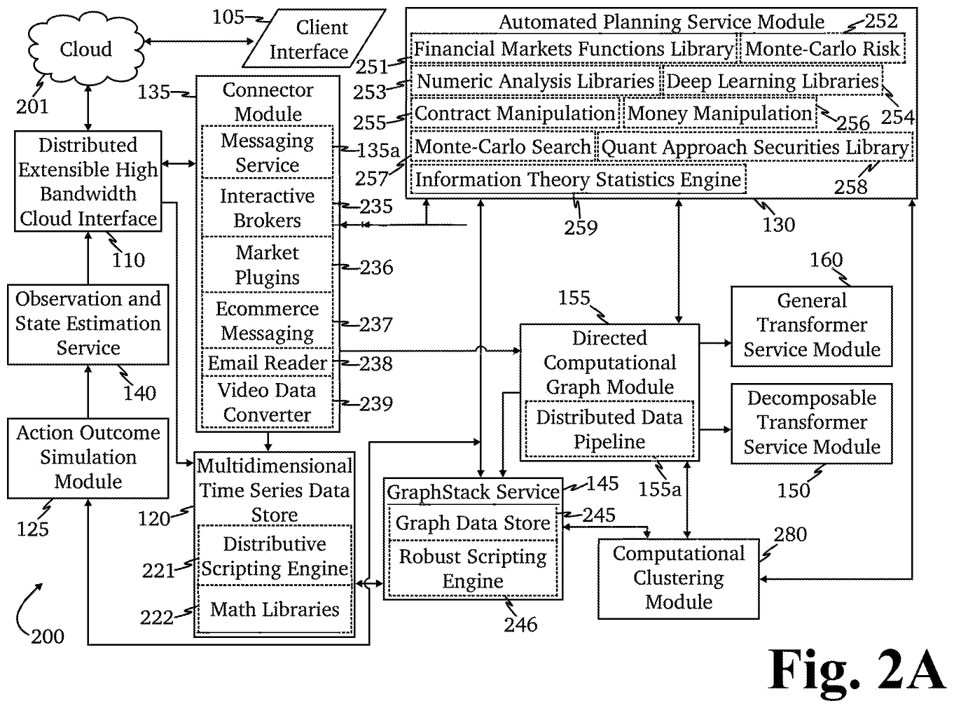

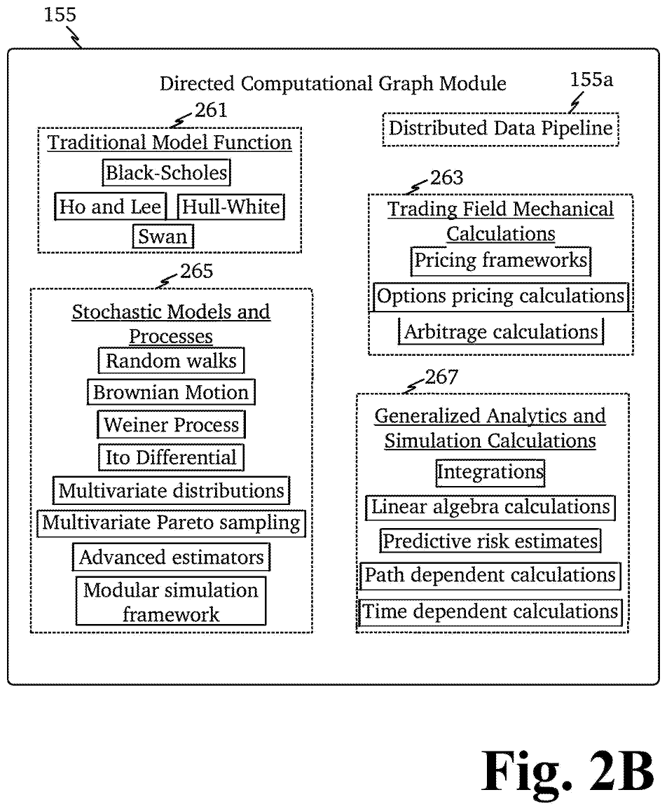

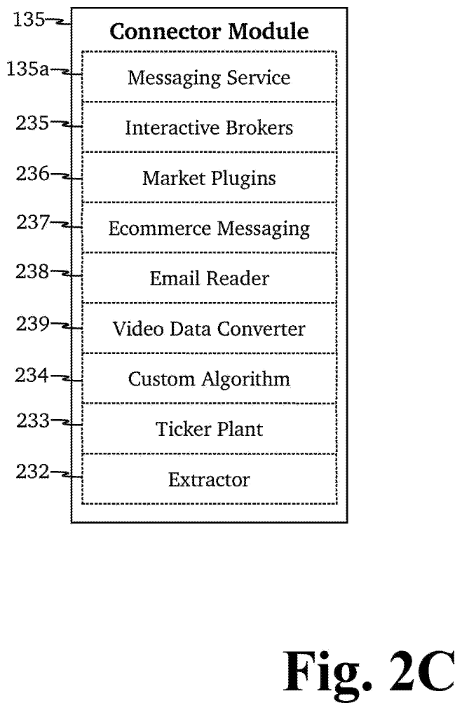

FIG. 2A is a diagram of components of the advanced decentralized financial decision platform 100 configured specifically for use in investment vehicle management according to an embodiment of the invention 200. The business operating system 100 previously disclosed in co-pending application Ser. No. 15/141,752 and applied in a role of cybersecurity in co-pending application Ser. No. 15/237,625, when programmed to operate as quantitative trading decision platform, is very well suited to perform advanced predictive analytics and predictive simulations to produce investment predictions. Much of the trading specific programming functions are added to the automated planning service module 130 of the modified business operating system 100 to specialize it to perform trading analytics. Specialized purpose libraries may include but are not limited to financial markets functions libraries 251, Monte-Carlo risk routines 252, numeric analysis libraries 253, deep learning libraries 254, contract manipulation functions 255, money handling functions 256, Monte-Carlo search libraries 257, and quant approach securities routines 258. Pre-existing deep learning routines including information theory statistics engine 259 may also be used. The invention may also make use of other libraries and capabilities that are known to those skilled in the art as instrumental in the regulated trade of items of worth. Data from a plurality of sources used in trade analysis are retrieved, much of it from remote, cloud resident 201 servers through the system's distributed, extensible high bandwidth cloud interface 110 using the system's connector module 135 which is specifically designed to accept data from a number of information services, either public or private, through interfaces to those service's applications using its messaging service 135a routines, due to ease of programming, are augmented with interactive broker functions 235, market data source plugins 236, e-commerce messaging interpreters 237, business-practice aware email reader 238 and programming libraries to extract information from video data sources 239.

Other modules that make up the advanced decentralized financial decision platform 100 may also perform significant analytical transformations on trade related data. These may include the multidimensional time series data store 120 with its robust scripting features which may include a distributive friendly, fault-tolerant, real-time, continuous run prioritizing programming platform 221 such as, but not limited to, Erlang/OTP, and a compatible but comprehensive and proven math library functions 222, for example C⁺⁺ math libraries, data formalization and ability to capture time series data including irregularly transmitted burst data; the GraphStack service 145 which transforms data into graphical representations for relational analysis and may use packages for graph format data storage 245, such as Titan or the like, and a robust scripting engine 246, which may be a highly accessible programming interface, an example of which may be Akka, although other, similar, combinations may equally serve the same purpose in this role to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results may be presented to clients 105 in formats best suited to convey the both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 125. Data and simulation formatting may be completed or performed by the observation and state estimation service 140 using its ease of scripting and gaming engine to produce optimal presentation results.

In cases where there are both large amounts of data to be cleansed and formalized, and intricate transformations such as those that may be associated with deep machine learning, first disclosed in ¶067 of co-pending application Ser. No. 14/925,974, predictive analytics and predictive simulations, distribution of computer resources to a plurality of systems may be routinely required to accomplish these tasks due to the volume of data being handled and acted upon. The business operating system employs a distributed architecture that is highly extensible to meet these needs. Additionally, a number of the tasks carried out by the system may be extremely processor intensive. For these processor-intensive tasks the highly integrated process of hardware clustering of systems, possibly of a specific hardware architecture particularly suited to the calculations inherent in the task, may be desirable, if not required, for timely completion. The system includes a computational clustering module 280 to allow the configuration and management of such clusters during application of the business operating system. While the computational clustering module is illustrated in FIG. 2A as directly connected to specific co-modules of the business operating system, these connections, while logical, are for ease of illustration and those skilled in the art may realize that the functions attributed to specific modules of an embodiment may require clustered computing under one use case and not under others. Similarly, the functions designated to a clustered configuration may be role, if not run, dictated. Further, not all use cases or data runs may use clustering.

Additionally, within the large amounts of data gathered and stored, a substantial amount of the stored data may require frequent updating, for instance, stock symbols and corresponding prices, which may prove to be time-consuming. Business operating system 100 may be configured to autonomously and continuously gather data in a background process, for example, using subroutines of connector module 135, such as email reader 238 or market plugins 236; using subroutines of automated planning service module 130, such as financial markets function library 251; using web crawler module 115 to scour news financial news sites; or using time series data store 120 to receive updated stock pricing at regular intervals. The data may then be processed and used by business operating system 100 to improve and update stored data. These operations may include, but not limited to, semantic extraction from corporate news and macro data; cross-linking to GraphStack entries; and automated time series feature engineering through the use of libraries like TSFresh, or using dimensionality reduction. Additionally, the high-bandwidth capabilities of business operating system 100 enables low-latency links to market data providers and venues to provide a nearly real-time channel to market data for the user using a ticker plant module 233 shown in FIG. 2C. The data that may be provided by market data providers and venues may include, but is not limited to, stock symbols and pricing, order book information, fill reports, news, and fundamentals. Business operating system 100 may also be configured to perform error-checking and self-heal the data as it is received.

In fields like finance, risks may be plentiful, and may come from many diverse sources. The source of risks may include, but is not limited to, systemic risks, for example collapse of a stock market; government risks, for example new regulations or legislative activity; and general risk, for example operational risks, disasters, personnel risk, and legal risks. With business operating system 100 configured to analyze market data, and other external data sourced from, for instance, financial news outlets or expert opinion, and analyzed using functions such as Monte Carlo risk routines 252, business operating system 100 may be able to take into consideration the various risks, and more accurately determine their adverse effects on financial holdings. This may enable a user to stay on top of potential downward trends, and offer them the opportunity to take action in the face of new risk development.

FIG. 2B is an extension of the advanced decentralized financial decision platform 100 shown in FIG. 2A showing directed computational graph module 155 further configured to perform financial data analysis using its associated transformer service module according to various embodiments of the invention. Specially configured directed computational graph module 155 may comprise routines for traditional model functions 261, trading field mechanical calculations 263, stochastic models and processes 265, and generalized analytics and simulation calculations 267. Traditional model functions 261 are operations involving standard models commonly used in the art. Examples of models used in traditional model functions 261 may include Black-Scholes, Ho and Lee, Hull-White, and Swan diagram modeling.

Trading field mechanical calculations 263 are operations involving standard pricing related calculations, for example, calculations involving pricing frames, options pricing calculations, and arbitrage calculations.

Stochastic models and processes 265 are operations relating to multivariate operations used in the art, for example, random walks process, Brownian motion, Weiner process, Ito differential, multivariate distributions (i.e. Markov chain Monte Carlo), multivariate Pareto sampling, and advanced estimators.

Generalized analytics and simulation calculations 267 are operations involving general mathematics, for example integrations, linear algebra calculations, predictive risk estimates, path dependent calculations, and time dependent calculations.

FIG. 2C is an extended connector module as illustrated in FIG. 2A. In addition to functions and features found in FIG. 2A, connector module 135 may also have a custom algorithm module 234, a ticker plant module 233, and an extractor module 232. Custom algorithm module 234 provides an interface to enable a user to add custom, user-created trading algorithms. The algorithms may utilize a rules-based system which is commonly found in business process modelling. For example, on a very basic level, a user may create algorithms to execute a particular trade when certain conditions are met, for instance when a certain order book spread occurs, or a stock arrives at a certain price. Ticker plant module 233, provides a low-latency, practically real-time link to market data sources that may provide information, such as pricing pertaining to stocks, bonds, commodities, futures, options, and currencies. Extractor module 232 may be used by business operating system 100 to intelligently extract relevant information from sources such as current events, news, and sentiment and may be configured to extract information based on region or sector. The extracted information may be cleansed and processed for use in other modules of business operating system 100.

It should be understood that the routines and subroutines illustrated in in FIGS. 2B and 2C are not intended to be comprehensive, and should instead be seen as an example of operations that may be configured for directed computational graph module 155 with the associated transformer modules, and connector module 135. The operations listed are also not required to all be run in a single process, and may be selected and executed piecemeal in a modular manner depending on the requirements of the user.

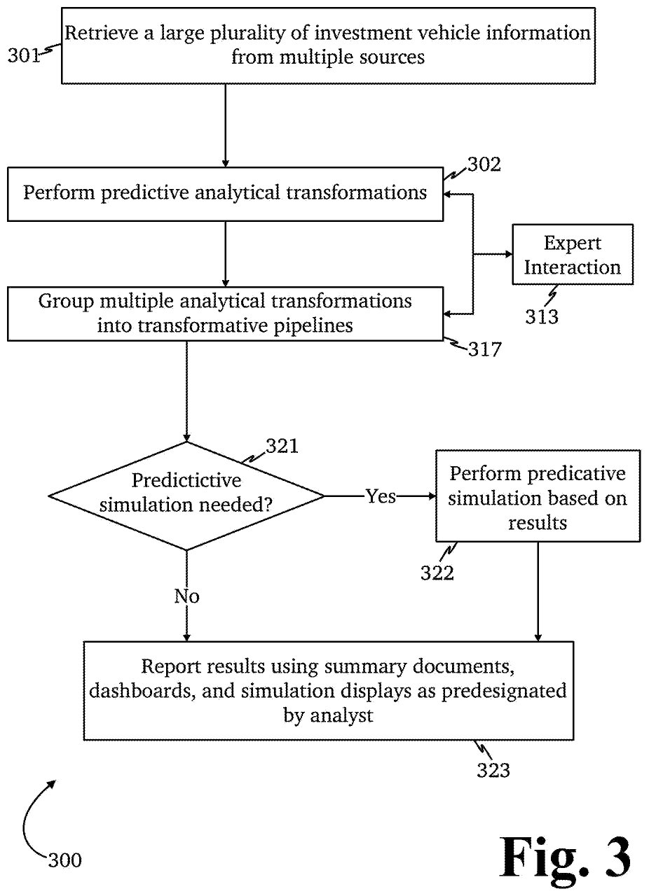

FIG. 3 is a flow diagram 300 of an exemplary function of the advanced decentralized financial decision platform 100 in the calculation of future investment performance. New investment opportunities are continuously arising and the ability to profitably participate in these new opportunities is of great importance. An embodiment of the invention 100 programmed to analyze investment trading related data and recommend investment vehicles may greatly assist in development of a profitable plan in potential new markets. Retrieval or input of any prospective new market related data from a plurality of both public and available private or proprietary sources acts to seed the process in step 301, specific modules of the system such as connector module 135 with its programmable messaging service 135a, high volume web crawler 115, and directed computational graph module 155, among possible others act to scrub, format, and normalize data from many sources for use. Such data is then subjected to predictive analytical transformations in step 302, which may include traditional model functions such as, but not limited, to Black-Scholes, Ho and Lee, and Hull-White; trading field mechanical calculations such as, but not limited to, pricing frameworks, options pricing calculations, and arbitrage calculations; and more generalized analytics and simulation calculations such as, but not limited to, integrations, linear algebra calculations, predictive risk estimations, stochastic processes functions, path dependent calculations, and time dependent calculations, all of which may serve to create the most accurate assessment of investment fitness given a particular vehicle and the large volume of data that surrounds and affects its current and predictable future performance. During the calculation process, there may be information added to the body of data by the input interaction of an analyst or other human expert party in step 313 to increase the accuracy of the interim calculated projections as one of the designed functions of the business operating system is to retrieve, cleanse and aggregate the overwhelming volume of data connected to a field of decision allowing human users to concentrate on the creative and higher order aspects of that data.

Many of the calculations above may be carried out as part of linear, branched or recursive pipelines using either general transformer service module 160, which may be specialized to rapidly perform linear transformation pipelines, and decomposable transformer service module 150 for branching and recursive pipelines in step 317. Again, expert interaction may be added at this point in the form of added data or modified programmed functions. At step 321, these results may then be formatted for direct display, formatted for further analysis by third party solutions or directly stored for later analysis, possibly in combination with other data in step 323, if no predictive simulation is needed. Otherwise, accumulated data may be used in the creation of predictive simulations prior to display of that simulated information in the desired format in step 322.

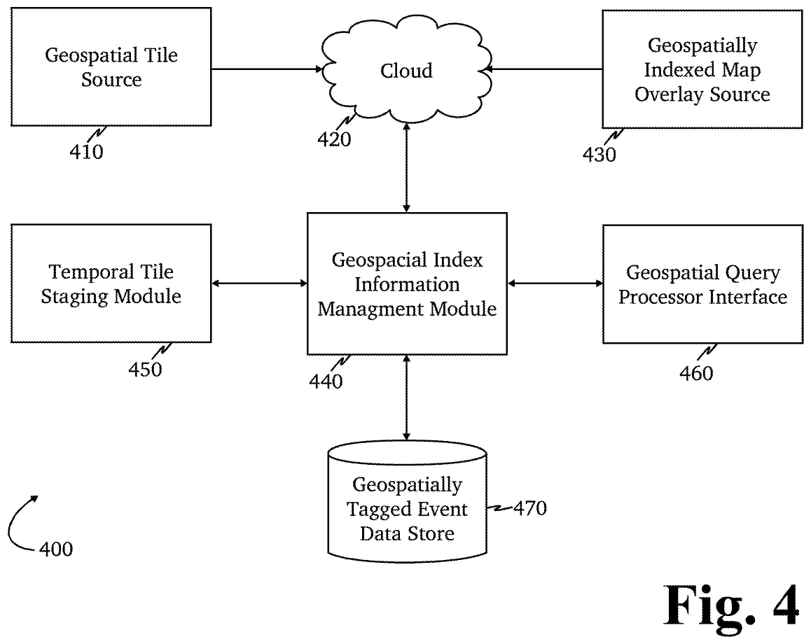

FIG. 4 is a diagram of an indexed global tile module 400 according to an aspect. A significant amount of the data transformed and simulated by the business operating system has an important geospatial component. Indexed global tile module 170 allows both for the geo-tagging storage of data as retrieved by the system as a whole and for the manipulation and display of data using its geological data to augment the data's usefulness in transformation, for example creating ties between two independently acquired data points to more fully explain a phenomenon; or in the display of real world, or simulated results in their correct geospatial context for greatly increased visual comprehension and memorability. Indexed global tile module 170 may consist of a geospatial index information management module which retrieves indexed geospatial tiles from a cloud-based source 410, 420 known to those skilled in the art, and may also retrieve available geospatially indexed map overlays from a geospatially indexed map overlay source 430 known to those skilled in the art. Tiles and their overlays, once retrieved, represent large amounts of potentially reusable data and are therefore stored for a pre-determined amount of time to allow rapid recall during one or more analyses on a temporal staging model 450. To be useful, it may be required that both the transformative modules of the business operating system, such as, but not limited to directed computational graph module 155, automated planning service module 130, action outcome simulation module 125, and observational and state estimation service 140 be capable of both accessing and manipulating the retrieved tiles and overlays. A geospatial query processor interface 460 serves as a program interface between these system modules and geospatial index information management module 440 which fulfills the resource requests through specialized direct tile manipulation protocols, which for simplistic example may include “get tile xxx,” “zoom,” “rotate,” “crop,” “shape,” “stitch,” and “highlight” just to name a very few options known to those skilled in the field. During analysis, the geospatial index information management module may control the assignment of geospatial data and the running transforming functions to one or more swimlanes to expedite timely completion and correct storage of the resultant data with associated geotags. The transformed tiles with all associated transformation tagging may be stored in a geospatially tagged event data store 470 for future review. Alternatively, just the geotagged transformation data or geotagged tile views may be stored for future retrieval of the actual tile and review depending on the need and circumstance. There may also be occasions where time series data from specific geographical locations are stored in multidimensional time series data store 120 with geo-tags provided by geospatial index information management module 440.

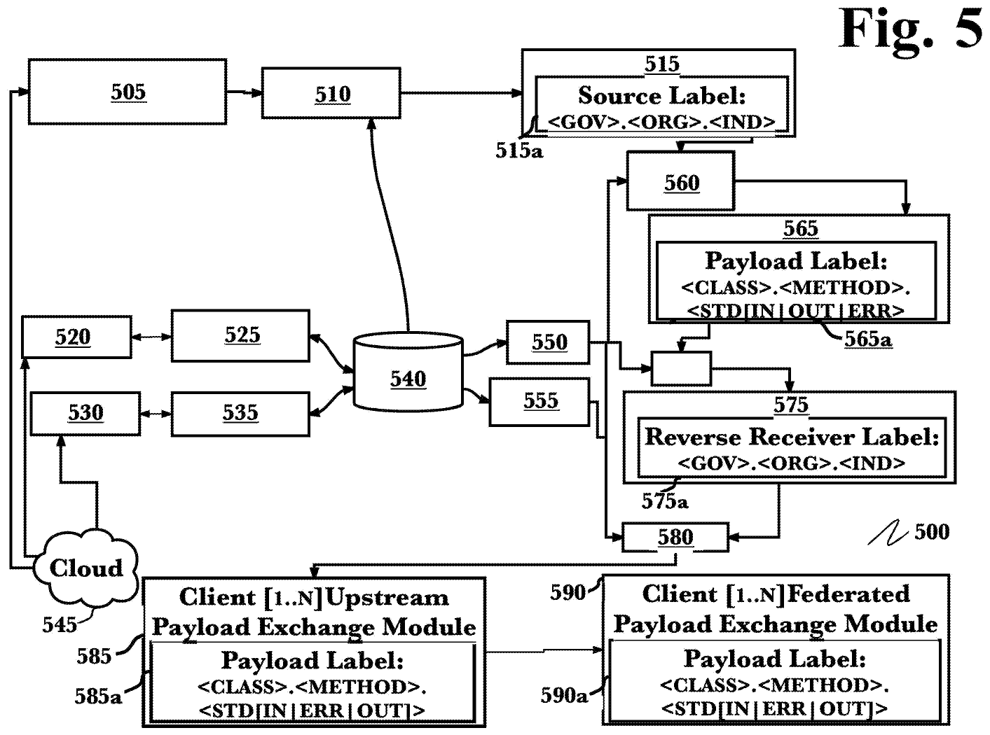

FIG. 5 is a diagram of an exemplary architecture of a regulatory label aware message routing system 500 according to an aspect. The embodiment works to simplify the exchange of messages containing sensitive and regulation controlled information by allowing routing boundaries, rules, policies and router handling programming for each to be centrally entered and then dictate message flow for the entire controlled WAN. The messages may enter the embodiment from external sources through a message label switch (MLS) aware messaging client 505 which is so named as it may set up routing paths based upon payload content dictated labels. The labels may contain policy and regulatory information pertaining to an individual, and pertaining to similar information connected to entities at an organization or government level. These messages may arrive at the messaging client already possessing a label designation for the source router, which may be software based, to be employed to send it, one or more labels disclosing the payload and thus designating the payload router, which again may be software based, to be targeted and a destination location indication of where the author requests the message sent 505. Designation of formal destination or “receiver” MLS aware router may be made by an MLS addresser module 510 which selects a receiver router for the message at least partially based upon the current rule, policy and regulation entries stored in a MLS rules write ahead data store 540. Once addressed with a receiving router, the message, now with its source router, payload router and receiver router designated, will pass to the source exchange module 515 which may serve as a message aggregator for the specified MLS source router 560. The source router, which may be software based may be implemented and configured upon arrival of a message payload requiring specific regulatory of policy dictated capabilities. Also shown is an MLS type source label which indicates an individual (IND), organization (ORG) and government (GOV) labeling structure 515a where information about the sender, the sender's organization and the sender's country or geographical zone may be disclosed. For example, “US.ABC1234MHOSP.NKEANMD” may identify Dr. Noa Kean at ABC1234 Memorial Hospital in the US. Each portion of this label may invoke pre-engineered programming rules within the regulatory label aware message routing system that affect the payloads that may be sent, who may send the payload and the receivers to which they may be transmitted. At this stage in the process a pre-programmed rule such as but not limited to whether NKEANMD may send messages from the source router may be exercised. If this example rule, together with other possible source router rules are passed, the message may be bound to the source router 560. A next process to occur prior to transmission of the message may be the analysis of the payload label plus any other policy markers that may accompany the message header in preferred aspects, in a payload exchange module 565. The payload label may of be the form “payload class” <CLASS>, “payload method” <METHOD>, and “payload origin” <STDIN|OUT|ERR> 565a. This label, like that for binding the source router, invokes pre-engineered programming pertaining to the characteristics of the payload contained in the message as disclosed by the payload label and in at least some instances, additional policy markers attached to the message possibly in a header stack. One of a great plurality of examples may be payload containing a HIPAA regulated patient record possessing a “PRECORD.TRANSFER.STDOUT” label. Some pre-programmed rules that may be applied are whether the sending individual, Dr. Kean in our example, may legally access and send the payload. A failure to pass this test or other tests, individually or in combination (where the ‘AND’ conjunctive is implicitly in effect by default but ‘OR’ disjunctive may also be used) may stop the transaction. Another rule may address whether ABC1234 Memorial Hospital may send the HIPAA regulated payload to the intended recipient and a last pre-programmed rule may determine whether the recipient has the credentials to receive the HIPAA protected payload. If all payload routing rules and policies are met, the message will be bound to the payload router 570, which may be implemented and configured on-the-fly and the message may then be transmitted to the receiver exchange module 575 which serves as an aggregator for incoming messages to that router using a more global reverse receiver message, which while it has the general form of <GOV>.<ORG>.<IND>may use a more generic form of the label where the individual recipient is programmatically substituted with a generic, all inclusive, identifier (*).

The transfer to the receiver router, more than others, may involve the transmission of the message from one regulatory label aware message routing system, which itself may be highly distributed to another distributed regulatory label aware message routing system, possibly requiring a plurality of intermediary hops. Due to the use of message layer routing (OSI 7/8) instead of packet layer routing (OSI 3) and a networking protocol, multi-protocol label switching (MPLS), which, among a plurality of other capabilities, may allow an edge router, which the source router may be considered an example, to specify the router for the next hop in the path to the ultimate destination as well as possibly designating the ultimate destination router. At each intermediate router along the pathway the current router may strip its designation from the list and add that of the chosen next hop router in its place. An extension of MPLS may also allow labels constraining the travel of the routed message to routers with specific capabilities, possibly security protocols or message integrity related, or geographical zones, for instance only within the US, to be placed on the label stack such that only network routers with those characteristics may be used. This feature of adding policy labels may allow individuals, organizations and governments using regulatory label aware message routing system services to easily ensure that their network messages fulfill all necessary data transfer laws and regulations.

While <GOV>.<ORG>.<IND> 515a and <CLASS>.<METHOD>.<STDIN|OUT|ERR> 565a may be expected as common MLS router and MLS payload label sets, other embodiments may use labels having different informational constituents that are known to that messaging network system but are not <GOV>.<ORG>.<IND> or <CLASS>.<METHOD>.<STDIN|OUT|ERR> as the invention does not specify what label types must be used or the number of label types that constitute a valid label. This feature provides a greatly expanded set of the types of information may be used and may provide a large degree of flexibility for evolution of the system as laws, regulations and corporate practices continue to change.

Messages sent from a source to a receiver successfully are aggregated in the receiver router's receiver exchange module 575. There, label constituents and associated policy labels may be inspected to confirm that the receiving government or organization facility is authorized to receive the payload. For example the message from “US.ABC1234MHOSP.NKEANMD” that apparently includes a patient record as the payload “PRECORD.TRANSFER.STDOUT.” As the receiver may be another hospital in the US, “US.WXYZ54321MHOSP.*” 575a which may be programmatically implemented on a physical node on-the-fly so most likely has all processes for the receipt of HIPAA governed materials already in place, the message is expected to be received and placed in a client upstream payload exchange module where the ability of the receiving individual, Dr. Jo Wilson, may be confirmed using the payload label 585a in an upstream payload exchange module 585 before being placed in a client federated payload exchange module 590 for the recipient, J. Wilson, MD. under the handling requirements for the materials listed in the payload label 590a. In cases where a single message arrives with more than one recipient, the entire message may be duplicated such that each recipient gets an autonomous copy of the message which may be modified or tracked per programmed rules of the embodiment.

Laws, regulations and both corporate and network service policies may change significantly over time. Embodiments of the regulatory label aware message routing system provides the ability to write routing rules using a plurality of programming languages and may have extension libraries for at least a subset of those languages to allow for the precise and efficient codification of message handling actions such that all nuances of these important, potentially complex directives may be accurately represented. Programming of route or policy directives may be accomplished remotely 545 in most embodiments using programming interface clients specific for either route rule command entry 520 or route policy command entry 530. Certain aspects may use only direct MLS programming client connections for route rule programming changes, policy rule programming changes or both to maintain a higher level of security. MLS route rule programming is normalized in an MLS route writing module 525 and, upon confirmation of the authority of the programming author by the MLS route writing module may be committed to an append-only MLS rules write-ahead data store 540 for persistent storage. Similarly, MLS policy rule programming is normalized in an MLS policy writing module 535 and, upon confirmation that the author of the new programming is authorized to add rule code to the routing system, committed to the append-only MLS rules write ahead data store 540 for persistent storage.

For maximal forensic analysis opportunity and change tracking capabilities, embodiments of the write ahead log 540, which hold the current, working, set of both routing and policy rules as well as records of all previous rules may incorporate a distributed ledger. One distributed ledger mechanism that may be used are available blockchains such as BITCOIN™, FACTOM™, LBRY™ and BIGCHAINDB™ among others where any modification of previous entries once committed is extremely difficult, if not impossible. While these blockchain services currently suffer from low data storage ceilings and may require purchase of cryptocurrency per unit storage, this drawback may be overcome by embodiments by combining secured, conventional database storage to store the full rule programming information while using one of the blockchain services to store hash recorded information to serve as the ledger. Another mechanism for secure, persistent write ahead log change tracking that may be used by embodiments is to control the change of route and policy rule programming through smart contracts or some other, similar vehicle known to those skilled in the art.

Translation of the current router and policy rules of the write ahead log 540 into the router 560, 570, 580 behavior of the embodiment may be performed by the MLS route module 550 for router rules and the MLS policy module 555 for policy expressions. These modules may perform updates by destroying existing software-based routers and creating new routers compliant for the newest rule state or by updating the existing router or routers to reflect the current rule status based upon instantaneous embodiment conditions or implementation. This allows for the most efficient rule entry to rule implementation pathway based upon the specific needs of the embodiment.

As embodiments are designed to be a distributed service, each of the described features may individually take place on different physical servers possibly residing in separate, distant, data centers.

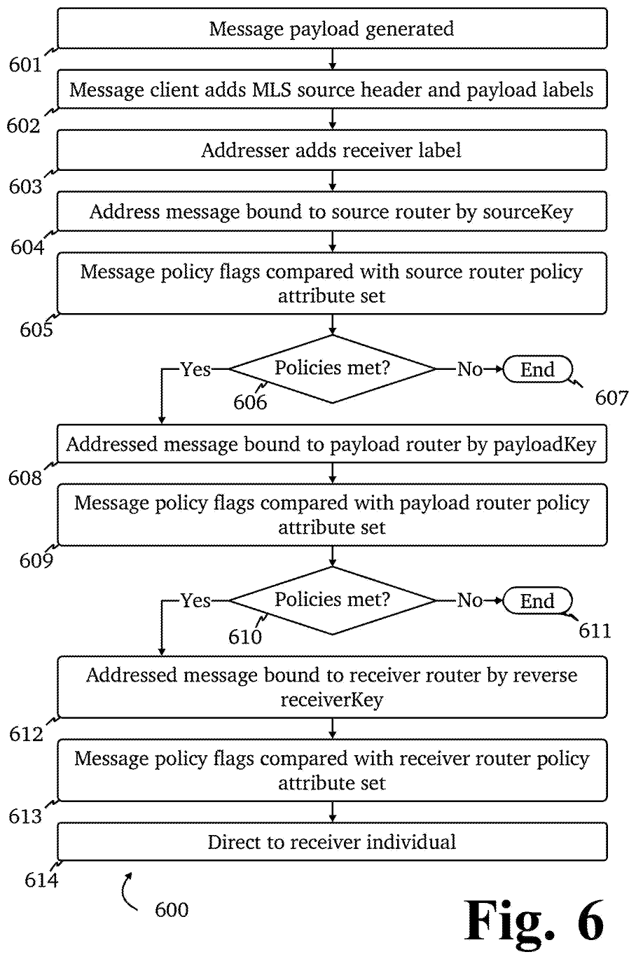

FIG. 6 is a flow diagram of an exemplary function of a regulatory message label aware message routing system 600 in routing sensitive electronic messages according to an aspect. The message payload is generated by the message client and may include data comprised of one or more of a plurality of both sensitive or regulated information parts which in turn may include but are not limited to personal identification information such as bank account numbers, personal identification numbers (ex. a social security number, driver license number, or similar such code known to those skilled in the art), national security and defense information, or intellectual property information, just to name a few examples of the focus of the function of the embodiment, and non-regulated portions 601. During the creation of the message, the author may also indicate the entity meant to receive the message. The message client may then create a header specifying the source of the message as well as the contents of its payload in the message's payload level header, placing labels, also known as “keys” corresponding to <GOVERNMENT>, <ORGANIZATION>, and <INDVIDUAL> for the source router of the message and <CLASS>, <METHOD>, and <ORIGIN> describing the payload 602. Source router label information within the header and the payload description label information may then be used to address the message to a receiver router based upon the contents of the message header, the intended recipient and the current routing rules and policies stored within the embodiment 603. It is possible that the combination of the message header's source router and payload keys and the current embodiment's router rules and policies, no acceptable receiver router will be generated as the message may not be sent to the intended recipient. Under this condition when the message is bound to the source router by the header's sourceKey 604, this routing rule failure or some other routing rule or policy failure later determined 605 may lead 606 to the message not being sent 607 in which case the message client (FIG. 5, 505) may be informed. The nature and restrictions upon the payload of the message may also be determined based upon the embodiment's message client generated payload label designations 609 after the message is aggregated upon passing through the source router and bound to the payload router 608. Again, failure to comply with routing rules and policies based on payload contents may lead 610 to a failure of the message to progress to the intended recipient 611 for security, secrecy, or statutory restrictions, just to name a few examples of delivery failure categories familiar to those skilled in the art and handled by embodiments. Upon successful inspection of the payload key with all rules and policies fulfilled, the message may be sent to the recipient. This may be done by first sending the message to a receiving router for the organization, ignoring the receiving individual and may take multiple transitions between connected routing appliances (hops) to accomplish. These hops are pre-specified by embodiments with the header receiver label first pointing to the first intermediate hop router, which upon reaching the first intermediate hop router is stripped from the header and replaced by the label for the second intermediate hop router and so on, the process of substituting the receiving router label repeating until the ultimate destination router is reached. The path or router hops taken may be affected by other policy or router rules such as but not limited to restrictions on geographical zone or region or information protection protocols present, that each router must fulfill, for example “US”, “defense department controlled” or “HIPAA safeguards in place” to name just a few illustrative possibilities, the message may be restricted only to MLS routers in the US, restricted only to MLS routers controlled by the military, or only MLS routers running specific information handling or protection protocols, HIPAA protections, in the example. Upon reaching the originally designated receiving MLS router 612, often serving the organization to which the receiving individual belongs 613, the MLS header including all labels may be stripped the message forwarded, provided that individual is determined to be authorized to handle the sent information 612, using lookup for the recipient individual, the message is delivered using classic OSI layer 3 routing and layer 2 switching 614.

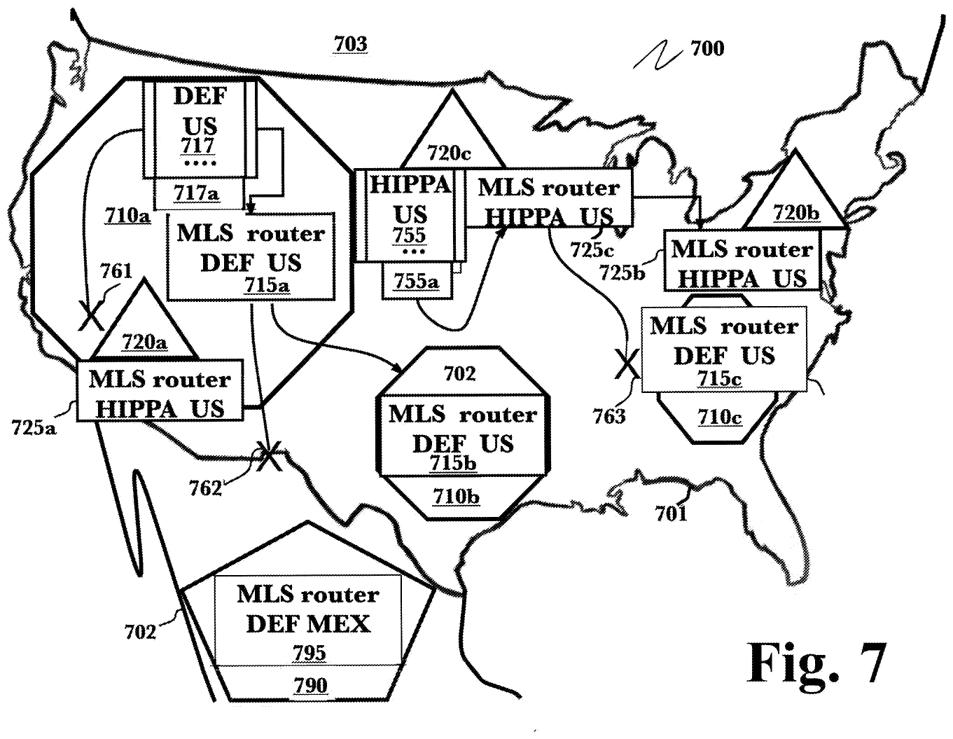

FIG. 7 is a diagram illustrating the use of routing regulatory labels to create availability zones 700. One way of characterizing the areas where message payloads governed by equivalent regulations and policies is through the construct of availability zones. Availability zones may be a large geographical region such as a country, for example the United States 701, Mexico 702 and Canada 703 just to list three of the plurality known to those skilled in the art. Other availability zones may result from the presence of a specific organization such as but in no way limited to military installations 710a, 710b, 710c and 790 which may possess the ability to process defense regulated messages 715a, 715b, 715c or health care facilities 720a, 720b, 720c which may occupy geography as small as a single building and be equipped to process HIPAA regulated messages 725a, 725b, 725c. Based upon these availability zones and MLS actionable labels, messages may be tightly controlled for transmission and delivery. A USA (US) defense (DEF) regulated and labeled message 717 with an MLS header 717a may thus be sent to USA military installations such as but not limited to bases and buildings 710a-c over MLS service routers 715a, 715b, 715c. When employed sensitive US defense (DEF) messages 717 may be successfully sent from the source router 715a to one or more destination receiver routers 715b and 715c within other US DEF availability zones 710b, 710c. Messages with US and DEF labels, signifying they are regulated by rules for US and DEF will not be sent 762 to a DEF availability zone for Mexico (DEF MEX) 790 as the MLS router 795 has only the credentials imparted by “DEF.” The same message will not be sent 761 to a US HIPPAA compliant availability zone 720a as the HIPAA MLS router in the zone lacks DEF authorization. Similarly, a health care message payload 755 with a MLS compliant header 755a will be successfully sent by a HIPAA compliant MLS source router 725c to a HIPAA compliant MLS router 725b at a second HIPAA credentialed availability zone 720b but not to a US DEF authorized availability zone 710c which lacks HIPAA data handling protocols 763. Embodiments may route messages through compliant MLS router exclusive paths 715a to 715b to 715c when intermediate hops are required. Failed message transmission attempts 761, 762, 763 would fail prior to transmission out of the source availability zones. Partial paths in those samples were solely to illustrate the intended, failing target.

Certain embodiments may routinely encrypt the payload or handle payloads with task specific encoding such as but not limited to structured threat information expression (STIX), trusted automated exchange of indicator information (TAXII), and cyber observables (CybOX), among other similar offerings known to those skilled in the art.

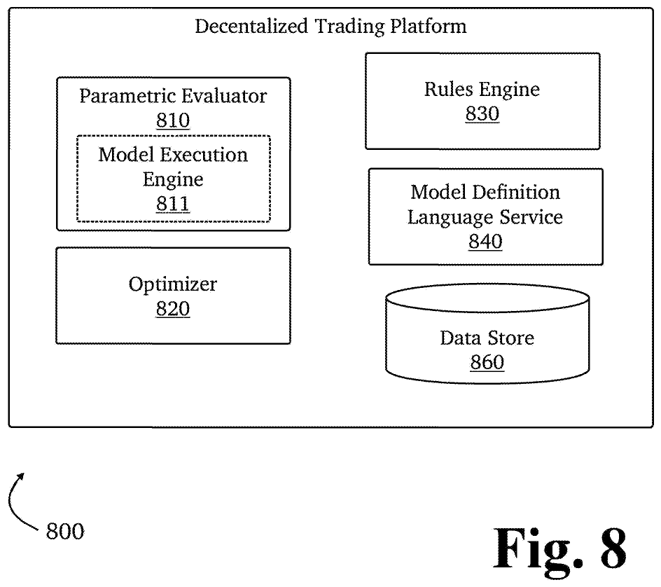

Advanced decentralized financial decision platform 100, and the systems and methods discussed above, while proficient and analyzing and predicting changes in financial markets, may require additional configuration to be more adept in dealing with the distributed nature, and latency dependence of globally distributed high-frequency trading. FIG. 8 is a block diagram of an exemplary system architecture for a system 800 for decentralized trading according to various embodiments of the invention. System 800 may comprise a parametric evaluator 810, an optimizer 820, a rules engine 830, a model definition language service 840, and a data store 860. System 800 may use functions of business operating system 100 to continually monitor and track current status of connections and system states. For example, sensor capabilities may be used to collect and store time-series data in multidimensional time-series data store 120, or observation and state estimation service 140 may be used for continuous monitoring. Connection and system data may additionally be indexed with a global tile module 170.

It should be understood that the components of system 800 may be in logical form, or may be an external service. Other embodiments of system 800 may have less components than what is shown in FIG. 8, while other embodiments may have additional components. A messaging system, such as the system discussed in FIGS. 5-7, may be used to route labeled data sent from system 800.

Parametric evaluator 810 may be configured to assess model performance and bias, and may comprise a model execution engine 811. Parametric evaluator 810 may utilize functions of business operating system 100, such as DCG module 155 with associated transformer modules or automated planning service 130, to analyze a plurality of data flow localities and priorities, and compile a list of results according to predefined factors, such as overall associated costs, volatility, profitability, effectiveness of global system optimizations, and the like.

Model execution engine 811 may utilize functions of business operating system 100, such as DCG module 155 with associated transformer modules or automated planning service 130, to analyze and parameterize a plurality of vectors, and their outcomes when given a plurality of factors relating to a trade, such as overall cost, effectiveness in global system optimization, profitability, volatility, and the like. The parameterization of a vector description may result in a “run”, which may be sent to optimizer 820 for further processing and analysis.

Optimizer 820 may be configured to use functions of business operating system 100, such as DCG module 155 with associated transformer modules, or automated planning service 130, to analyze “runs” that received from parametric evaluator 810, and generate recommendations regarding appropriateness of one or more data flow localities, such as regulatory issues or legality, or utility for one or more sets of exogeneous factors or system states. For example, optimizer 820 may recommend a combination of data flow and storage localities based on current global system states to determine a course of action for one or more financial trades resulting in favorable outcomes by choosing whether to migrate data, migrate processes, or call into spot markets to control data and processing locality in order to minimize latency associated with execution trades across geographically distributed market centers; or analyzing hypothetical system states, such as using simulation engines, either provided by business operating system 100 or an external simulation system, to operate an identical instance in simulation to identify current and future bottlenecks.

When used in handling of rules, optimizer 820 may be configured to define a set of rules pertaining to the appropriateness of data locality and process locality with regards to a system condition for a given purpose, for instance, for determining profitable trades, which may be expressed in a declarative formalism accessible to rules engine 830. When used in conjunction with machine learning methods, such as deep learning, transfer learning, reinforcement learning, and the like, optimizer 820 may develop an understanding of optimal models, groups of models, or rules defining model appropriateness or performance over time; and may change or restrict ordering of model packages or rules combinations based on the developed understanding.

Rules engine 830 may be configured to use functions of business operating system 100, such as DCG module 155 with associated transformer modules, graph stack service 145, and automated planning service 130, to enable management of system rules, and also to evaluate specific elements of a given instance of one or more models when given any definition for the current or future state of said models. For example, rules engine 830 may verify that a request is allowed or appropriate based on the intended use, for example, feasibility or legality of an intended trade; whether a defined confidence requirement or other conditions are met; and evaluate configuration-specific terms and requirements as specified in user-defined operating constraints or guidelines. Rules engine 830 may evaluate rules by executing a forward chaining deduction of data amassed from a set of antecedents derived from model definition language service 840 for a particular application or purpose. Rules engine 830 supports layered “batteries” of modular tests, where functional decomposition of rules supports higher degrees of user productivity and rules re-use.

Model definition language service 840 may be configured to use functions of advanced decentralized financial decision platform 100, such as DCG module 155 with associated transformer modules, graph stack service 145, and automated planning service 130, to allow user management of models, and defining of vectors using a declarative specification language (DSL). The use of a DSL for vectorizing the compute environment and data flow descriptions may enable linking of search processes to the rules engine 830, parametric evaluator 810, and feedback loop processes during ongoing operational-use based on the ability to encode appropriateness when combined with rules engine 830, serving as a basis for deep and reinforcement learning to support ongoing improvement to functions of optimizer 820. Model definition language service 840 may also enable a user or an autonomous trading system to initiate evaluation of specific pipelines, activities, overall system health, and the like of a specific instance of system 800.

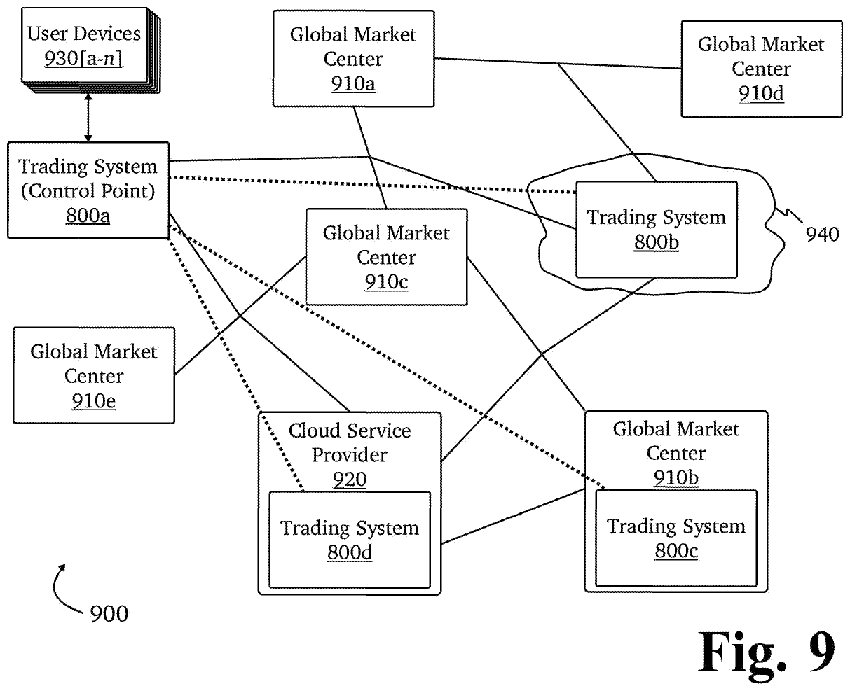

FIG. 9 is an illustration of an exemplary topography 900 of a system employing a plurality of decentralized trading systems 800[a-d] according to various embodiments of the invention. Topography 900 is an example of a layout of various components within a geographical area, for example spanning a continent or even on a global scale, and illustrates a plurality of systems 800[a-d] connecting with a plurality of user global market centers 910[a-e], such as a stock market or foreign exchange markets, through a wide area network connection; and a plurality of user devices 930[a-n], which may be a single user or group of users accessing trading platform 800a through, for example, a web application, mobile device, spatial operating system, AR or VR system, and the like.

Systems 800[a-d] may be flexible in their placement and locale, which may include, for example, as a standalone system 800a; running in a virtual machine of a cloud service provider, such as AMAZON AWS 920, 800d; residing inside a global market center 910b, 800c; or even submerged in a body of water 940, 800b, for example inside a mobile submersible data center. Locations for systems 800[a-d] may be strategically chosen, so that they may be useful in operating as an intermediate connection to a trading market. Topography 900 utilizes a centralized control point in system 800a for users to communicate with decentralized deployment of a plurality of instances of system 800[b-d]. Any particular instance may be chosen by an optimizer of system 800a as the locality for data processing and storage; or system in which to execute a trade based on metrics such as system availability, latency to reach a target global market for trading a certain asset, and the like.

It should be understood that the layout and components depicted in FIG. 9 is used for demonstration purposes, and does not represent a limitation of the present invention. For example, there may be more than one control point, more decentralized trading system endpoints, more global markets, and the like.

### Detailed Description of Exemplary Aspects

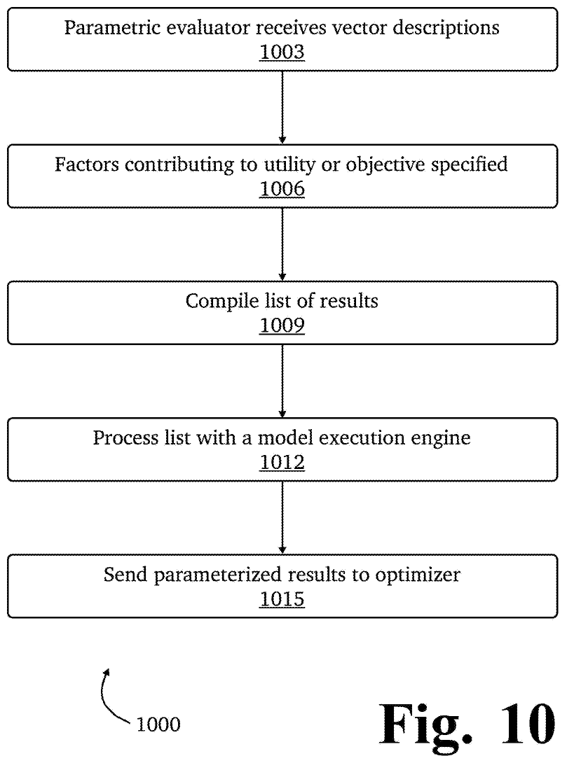

FIG. 10 is a flow diagram for an exemplary method 1000 for model evaluation using a parametric evaluator according to various embodiments of the invention. At an initial step 1003, parametric evaluator 810 receives a plurality of vectors. As discussed above, vectors may be specified by a user using model definition language service 840. At step 1006, factors contributing to overall utility or objective may be specified by either a user or an autonomous trading system. At step 1009, parametric evaluator 810 may compile a list of results based on performance and bias with regards to the vectors, and specified utility or objective. At step 1012, parametric evaluator 810 to processes the list of results using a model execution engine, which may generate one or more “runs”. At step 1015, parametric evaluator 810 sends the one or more runs to optimizer 820 for further optimization.

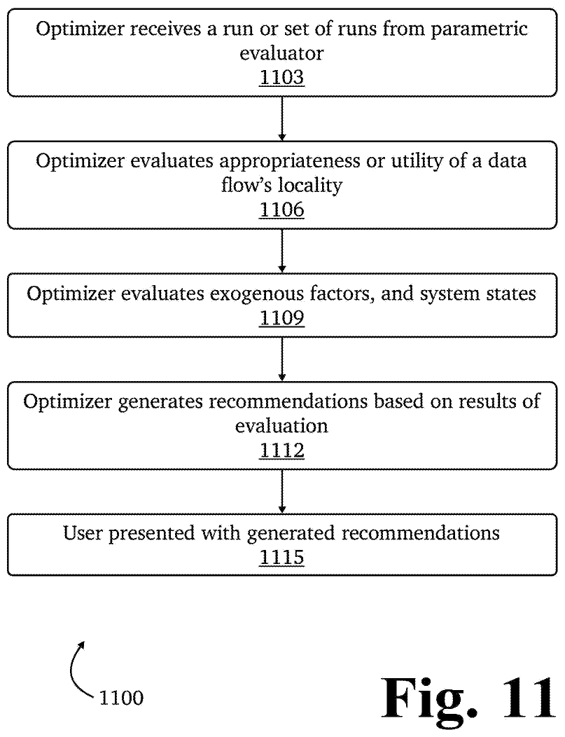

FIG. 11 is a flow diagram for an exemplary method 1100 for optimizing a request according to various embodiments of the invention. At an initial step 1103, optimizer 820 receives one or more runs from parametric evaluator 810. At step 1106, optimizer 820 evaluates appropriateness or utility of a run's data flow locality, for instance, whether the intended target instance is capable or allowed to execute a particular trade. At step 1109, optimizer 820 evaluates exogenous factors and system states of a target system, such as latency or other factors contributing to connection problems. At step 1112, optimizer 820 generates recommendations based on results of the evaluation conducted in steps 1106 and 1109. At step 1115, a user is presented with the recommendations. In some embodiments, the recommendations may be used by an autonomous trading platform, which may execute trades based on defined user preferences.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

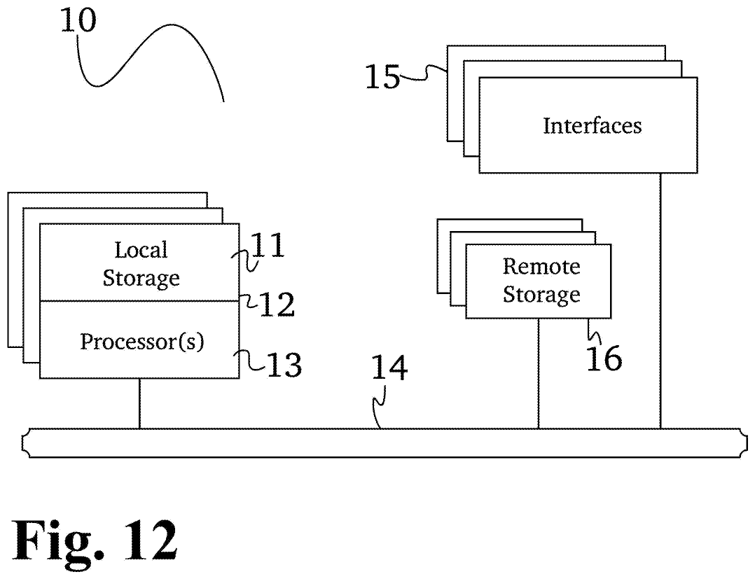

Referring now to FIG. 12, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 12 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

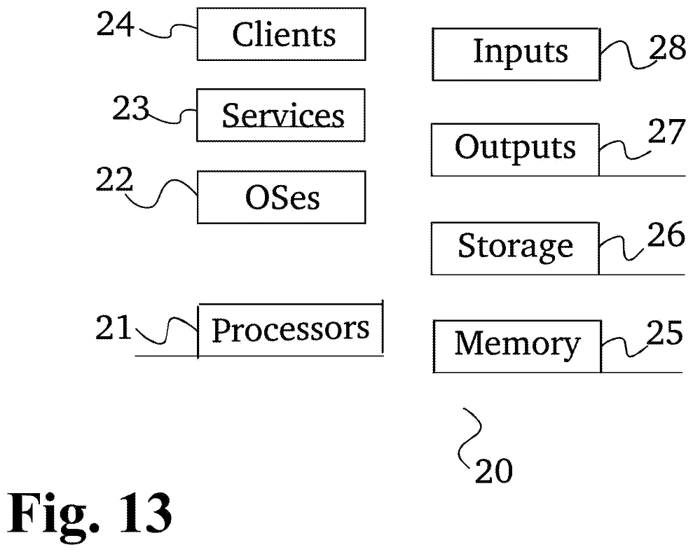

In some aspects, systems may be implemented on a standalone computing system. Referring now to FIG. 13, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 12). Examples of storage devices 26 include flash memory, magnetic hard drive, CD-ROM, and/or the like.

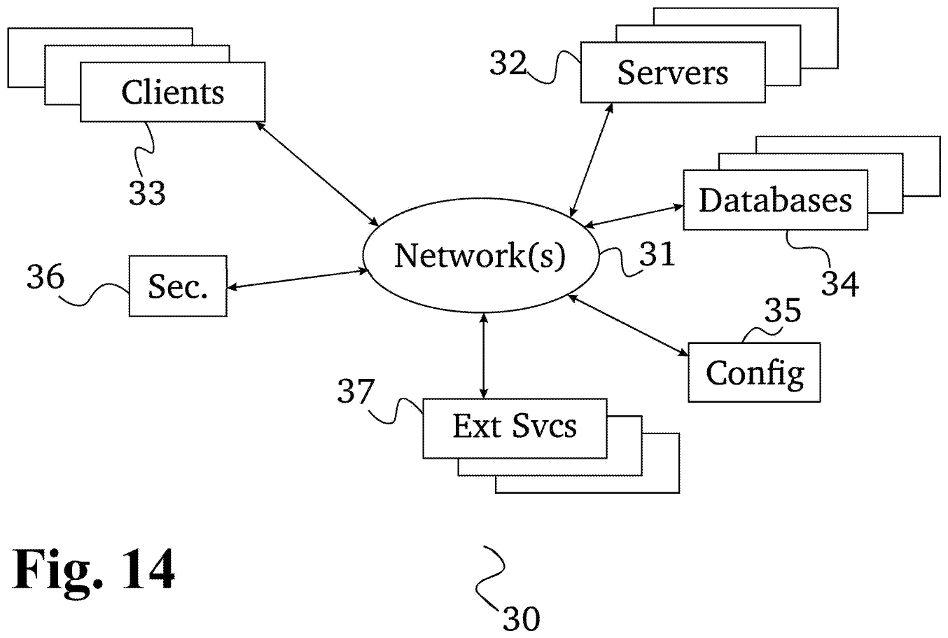

In some aspects, systems may be implemented on a distributed computing network, such as one having any number of clients and/or servers. Referring now to FIG. 14, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 13. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

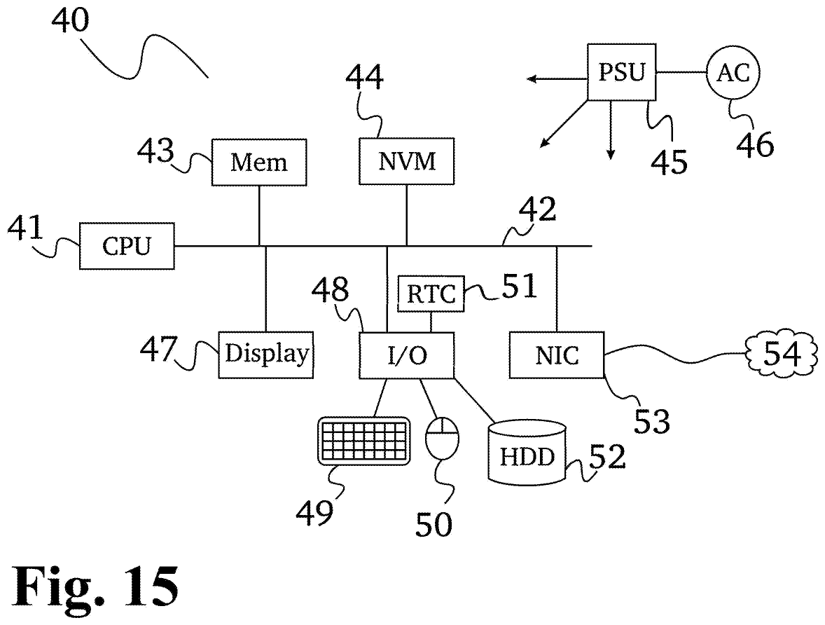

FIG. 15 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for a decentralized financial simulation and decision platform, comprising:
a computing system, comprising a memory and a processor;
a decentralized trading subsystem, comprising a first plurality of programming instructions that, when operating on the processor, cause the computing system to:
define a domain-specific language for a trading performance model, the trading performance model comprising a representation of a computing environment, a trading performance parameter, and a set of rules, the computing environment comprising:
a plurality of trading computers, located proximally to at least one trading exchange, and the location, trading configuration, and trading data of the plurality of trading computers;
a trading system control point server, and the location, trading configuration, and trading data of the trading system control point server; and
an end-user computer, and the location, trading configuration, and trading data of the end-user computer; and
send the domain specific language and trading performance model to the plurality of trading computers for evaluation;
an optimizer subsystem comprising a second plurality of programming instructions that, when operating on the processor, cause the computing system to:
receive test results from the plurality of trading computers;
determine an optimal configuration for trading based on the test results, the optimal configuration comprising a determination of what types of trades and what volumes of trades should be executed at which exchanges to reduce execution latency; and
implement the optimal configuration by distributing orders for trades among the plurality of trading computers; and
a rules engine subsystem, comprising a third plurality of programming instructions that, when operating on the processor, cause the computing system to:
analyze the trading performance model according to a set of rules contained within the domain specific language;
conduct one or more tests of the trading performance model at the location of the trading computer using the set of rules contained in the domain specific language to obtain a test result, the test result comprising a type of trade or a volume of trades that would be optimally placed at the location of the trading computer; and
wherein the domain specific language is deployed at each of the plurality of trading computers, and computed separately using each trading computer's own location, real or simulated latency to a trading exchange, and hardware specifications, for evaluation of heterogeneous trading computers and trading exchanges for a given trade, simulated trade, or trading model.

2. The system of claim 1, wherein the rules engine subsystem evaluates a rule in the set of rules concerning a legality of the trade based on regulations applicable to the location of the trading computer.

3. The system of claim 1, wherein the optimizer subsystem instantiates a separately instanced copy of the trading performance model to identify bottlenecks.

4. The system of claim 1, wherein network connections and system status among the plurality of trading computers, the trading system control point server, and the user computer are continuously monitored and tracked by the decentralized trading subsystem.

5. A method for a decentralized financial simulation and decision platform, comprising the steps of:
defining, at a decentralized trading platform, a domain specific language for a trading performance model, the trading performance model comprising a representation of a computing environment, a trading performance parameter, and a set of rules, the computing environment comprising:
a plurality of trading computers, located proximally to at least one trading exchange, and the location, trading configuration, and trading data of the plurality of trading computers;
a trading system control point server, and the location, trading configuration, and trading data of the trading system control point server; and
an end-user computer, and the location, trading configuration, and trading data of the end-user computer;
sending the domain specific language and trading performance model to the plurality of trading computers for evaluation, using a decentralized trading platform;
receiving test results from the plurality of trading computers;
determining, using an optimizer subsystem, an optimal configuration for trading based on the test results, the optimal configuration comprising a determination of what types of trades and what volumes of trades should be executed at which exchanges to reduce execution latency;
implementing the optimal configuration by distributing orders for trades among the plurality of trading computers, using the optimizer subsystem;
analyzing the trading performance model according to a set of rules contained within the domain specific language, using a rules engine subsystem;
conducting one or more tests of the trading performance model at the location of the trading computer using the set of rules contained in the domain specific language to obtain a test result, the test result comprising a type of trade or a volume of trades that would be optimally placed at the location of the trading computer, using the rules engine subsystem; and
wherein the domain specific language is deployed at each of the plurality of trading computers, and computed separately using each trading computer's own location, real or simulated latency to a trading exchange, and hardware specifications, for evaluation of heterogeneous trading computers and trading exchanges for a given trade, simulated trade, or trading model, using the rules engine subsystem.

6. The method of claim 5, further comprising the step of using the rules engine subsystem to evaluate a rule in the set of rules concerning a legality of the trade based on regulations applicable to the location of a specific trading computer.

7. The method of claim 5, further comprising the step of using a separately-instanced copy of the trading performance model to identify bottlenecks.

8. The method of claim 5, wherein network connections and system status among the plurality of trading computers, the trading system control point server, and the user computer are continuously monitored and tracked by the decentralized trading subsystem.
